(19) United States
(12) Patent Application Publication
(10) Pub. No.: US 2008/0309042 A1
(43) Pub. Date: Dec. 18, 2008

(54) Mounting Process for a Joint Arrangement as Well as Joint Arrangement for a Motor Vehicle Axle

(76) Inventors: Matthias Gercke, Affinghausen (DE); Holger Klanke, Bohmte (DE); Michael Mühl, Lengerich (DE); Björn Spaggiari, Osnabrück (DE)

Correspondence Address: MCGLEW & TUTTLE, PC, P.O. BOX 9227, SCARBOROUGH STATION, SCARBOROUGH, NY, 10510-9227, US

(21) Appl. No.: 12/095,010

(22) PCT Filed: Nov. 27, 2006
(86) PCT No.: PCT/DE2006/002094

§ 371 Date: May 27, 2008

(30) Foreign Application Priority Data
Nov. 28, 2005 (DE) 10 2005 056 877.7

(51) Int. Cl. B62D 7/18

(52) U.S. Cl. 280/93.512

(57) ABSTRACT

A process is provided for mounting a joint arrangement, especially for a driven axle of a motor vehicle, as well as, furthermore, to a joint arrangement, especially for a motor vehicle axle. The joint arrangement has a joint fork (1), which can be arranged in the area of a vehicle axle, and a steering knuckle (2), which carries the wheel bearing (3) and is pivotable in relation to the joint fork (1) by two mounting points (4, 5). One of the mounting points is designed as a fixed bearing (4) and the other mounting point is designed as a movable bearing (5) with an outer ring element (8) and an inner ring element (9), wherein the movable bearing (5) has an axial degree of freedom as well as an additional pivot angle degree of freedom. The mounting process provides that the joint fork (1) and the steering knuckle (2) can be designed as one-piece components thanks to a bolt (20) and a space-maintaining auxiliary mounting element (18). At the same time, the exact middle position of the inner ring (9) in the movable bearing (5) at the time of mounting is always guaranteed in a reproducible manner. While the service life of the product and failure safety increase at the same time, the necessary number of components, the space needed for installation, the non-spring-mounted masses, the effort needed for mounting as well as the manufacturing costs can be reduced as a result.

### CROSS REFERENCE TO RELATED APPLICATIONS

This application is a United States National Phase application of International Application PCT/DE2006/002094 and claims the benefit of priority under 35 U.S.C. § 119 of German Patent Application DE 10 2005 056 877.7 filed Nov. 28, 2005, the entire contents of which are incorporated herein by reference.

### FIELD OF THE INVENTION

The present invention pertains to a process for mounting a joint arrangement for a wheel guide, especially for a steerable, for example, driven axle of a motor vehicle, as well as to a joint arrangement.

### BACKGROUND OF THE INVENTION

Joint arrangements of the type mentioned in the introduction are used, for example, but by no means exclusively, in so-called split wheel carriers of, among other things, McPherson axles, shock absorber strut axles or double wishbone axles. Such split wheel carriers are characterized in that a pivotable insert, especially a steering knuckle, which is responsible especially for the steering motion proper of the wheel, is arranged on a part of the wheel carrier, which is spring-mounted but does not perform steering motions.

Such split wheel carriers offer especially the advantage that the essentially vertical steering axle, about which the wheel is pivoted during the steering motion, can be arranged with a smaller inclination angle as well as closer to the central plane of the wheel, without this leading to a great and/or positive roll radius at the same time. This reduces disturbing reactions especially of the driving or braking torque as well as the effects resulting from, for example, unevennesses of the road surface, wheel imbalance or lateral forces on the steering of the vehicle. In addition, the entire axle geometry, especially the cooperation of inclination, roll radius, track width and king pin angle as well as the axle pin rake can be better optimized in order to thus guarantee optimal guiding of the vehicle as well as sensitive steerability free from forces of reaction under all driving conditions and in the greatest possible range of the steering angles.

Such a two-part, split wheel carrier is known, for example, from the document DE 603 00 085 T2. This prior-art wheel carrier comprises a ball and socket joint as well as a roller bearing, the steering axis or the pivot axis of the steerable steering knuckle relative to the stationary part of the wheel carrier being set by the cooperation of these two joints. The steering knuckle can thus be pivoted, according to the teaching of this document, relative to a fork-shaped joint arrangement of the wheel carrier, which is spring-mounted but is stationary relative to steering motions, about the steering axis defined by the two joints, as a result of which the corresponding wheel of the vehicle experiences the steering motion.

The wheel guide joint formed by the two joints must be designed here as a fixed bearing/movable bearing combination in order to make it possible to absorb the inevitable manufacturing and mounting tolerances as well as the deformations of the joint and axle components occurring during operation. This is all the more true as such wheel carriers or wheel guide joints must be provided with a continuous recess, especially in case of driven axles, in order to make possible the necessary passage for the drive shaft of the wheel. However, the open and fork-shaped design of such a wheel carrier brings with it additional elasticities, which are manifested in deformations of the joint fork, of the steering knuckle or of the respective bearing flange as soon as forces of reaction such as road surface effects as well as driving, braking and centrifugal forces act on the wheel guide joint.

Thus, certain static and/or dynamic oblique positions and axial displacements between the pivotable steering knuckle and the stationary wheel carrier also develop in the area of the two bearings because of such forces of reaction.

A fixed bearing/movable bearing combination, which provides as a fixed bearing a rotatable and pivotable ball and socket joint, is used, in general, for absorbing such oblique positions or axial displacements on the bearing side according to the state of the art. Provisions are made here according to the state of the art for using either a plain bearing with two different bearing surface areas for rotation/pivoting as well as for axial displaceability as the movable bearing for the simultaneous absorption of any possible oblique positions as well as axial displacements between the pivotable steering knuckle and the stationary wheel carrier, or a rolling bearing with an additional axial degree of freedom as well as with an additional pivot angle degree of freedom, for example, a toroidal roller bearing, is used.

However, such prior-art wheel guide joints with fixed bearing and movable bearing can be manufactured at a high cost and, in particular, their mounting is complicated. This is linked primarily with the fact that the stationary wheel carrier according to the state of the art, designed usually as a joint fork, must be designed as a two-part wheel carrier in order to make it possible to mount the two bearing points, i.e., the fixed bearing and the movable bearing, between the wheel carrier and the steering knuckle, as well as the pivotable steering knuckle at all by means of the opening of the two-part joint fork. In other words, at least one of the fork ends of the stationary wheel carrier or the joint fork thereof must be designed as a separate component, which can be connected to the wheel carrier or the joint fork, for receiving one of the two drag bearings, cf. especially FIGS. 2 and 4 of the document DE 603 00 085 T2.

The mounting of the steering knuckle and the joint fork is carried out according to the state of the art such that the pivotable steering knuckle and the stationary joint fork are at first connected to one another by means of the upper fixed bearing designed as a ball and socket joint. The mounting of the lower movable bearing on the pivotable steering knuckle is carried out subsequently. After pivoting the steering knuckle into the stationary wheel carrier having a two-part design, the joint fork formed by this is finally closed, as a result of which the unit comprising the pivotingly movable steering knuckle and the stationary wheel carrier or joint ball, which unit is pivotable in itself, is produced.

However, on the one hand, this two-part design, which is necessary according to the state of the art, already has a complicated design and therefore tends to be expensive. In addition, the two-part design of the wheel carrier increases the number of components and hence the complexity of mounting the wheel carrier, the steering knuckle and the drag bearing. The non-spring-mounted masses of the wheel suspension, which are also decisive for the driving properties and the suspension comfort, are also increased in an undesired manner as a result.

Another decisive drawback of the split or two-part wheel carrier known from the state of the art is, however, that the large number of components, which is linked with the fact that the joint fork has to be designed as a two-part joint fork, may lead to problems concerning compliance with the close tolerances intended in the area of the drag bearing between the stationary wheel carrier and the pivotable steering knuckle.

This is due to the fact that the central position of the bearing components of the fixed bearing, which position is intended for the force-free state, must be maintained very accurately during the mounting of the wheel carrier to enable the movable bearing to absorb the oblique positions and/or axial displacements described, which occur during operation. However, a linking of tolerances, which is unfavorable in this respect, occurs because of the large number of individual components in the state of the art, which is due especially to the fact that the joint fork must be designed as a two-part joint fork, and the central position of the movable bearing can often be set with an insufficient accuracy only in joint arrangements according to the state of the art and can be reproduced only insufficiently in series production.

It may even happen in case of unfavorable tolerances that the axially displaceable movable bearing is already at the limit of its working range that is permissible concerning the axial displacement after mounting. The strains of the joint fork and/or steering knuckle, which occur especially during driving in this case because of effects of vehicle dynamics or even because of temperature effects, are no longer able now to be absorbed by the drag bearing of the steering knuckle in the form of pivoting and/or axial displacements of the movable bearing. However, uncontrolled deformation may develop as a result between the steering knuckle and the wheel carrier or the joint fork, which may then lead to a premature failure of the two drag bearing points of the steering knuckle because of bearing overload.

### SUMMARY OF THE INVENTION

Against this background, the object of the present invention is to provide a joint arrangement for wheel guiding and a mounting process for such a joint arrangement, whereby the drawbacks can be overcome. The process and the joint arrangement shall guarantee, in particular, an exact central position of the movable bearing in a reproducible manner in such a way that it is reliable in operation and is carried out in a reliable process. Furthermore, the joint arrangement shall be able to have the lowest possible weight, be as compact as possible and have the longest possible service life, and it shall also make possible an inexpensive, expedited production and mounting.

The process according to the present invention pertains to the mounting of a joint arrangement for a wheel guide, especially for an, e.g., driven axle of a motor vehicle. The joint arrangement comprises a joint fork, also called a static wheel carrier, which can be arranged on a vehicle axle or on a spring strut and can be connected to an axle guide device, as well as a steering knuckle, which carries the wheel bearing proper and assumes the steering function. Static wheel carrier and joint fork and axle guide means can be pivotably connected to one another by means of two axially aligned mounting points, one of the mounting points being designed as a fixed bearing and the mounting point as a movable bearing with an axial degree of freedom as well as an additional pivot angle degree of freedom. The movable bearing comprises an outer ring element as well as an inner ring element, which is rotatable in relation to the outer ring element and is at least slightly axially displaceable and pivotable. The steering knuckle of the joint arrangement has a bearing seat, on which the outer ring element of the movable bearing can be received.

The terms “outer ring elements” and “inner ring elements” used shall cover not only ring-shaped bearing components of rolling bearings, but also the components of, e.g., ball and socket joints, which components functionally correspond to the bearing rings.

The process according to the present invention comprises the following process steps:

Premounting of the fixed bearing is first performed in process step a), i.e., the components of the fixed bearing are premounted on the steering knuckle and/or on the joint fork.

The movable bearing is pressed into the bearing seat of the steering knuckle in another process step b), approximately simultaneously, the order of the process steps a) and b) not being essential for the present invention, in such a way that both the outer ring element and the inner ring element of the movable bearing are located at an end stop each, which are present each in the direction of pressing in.

In other words, this means that both the outer ring element and the inner ring element of the movable bearing, i.e., for example, the outer ring of the bearing as well as the inner ring of a toroidal roller bearing, or the joint housing, as well as the bearing shell of a ball and socket joint, which said bearing shell is axially displaceable therein, with an additional axial degree of freedom, both assume an exactly defined position in the axial direction at the respective stop of the bearing seat of the steering knuckle. Due to this exactly defined position of the outer ring element and inner ring element, which corresponds to a relative positioning of the outer ring element and the inner ring element that is eccentric in the axial direction of the bearing, an exact starting position of both the outer ring element and the inner ring element is thus established in a dimensional relationship to the steering knuckle, which is a prerequisite for the accurate and reproducible relative position of the outer ring element and the inner ring element in the central position of the movable bearing, which is performed later. It is not absolutely necessary for the inner ring element of the movable bearing to be also at its end stop in the bearing seat of the steering knuckle already when the movable bearing is pressed in. However, contact between the inner ring element of the movable bearing and this end stop must be guaranteed at the latest when the inner ring element is connected to the movable bearing-side fork end of the joint fork in process step e).

Premounting of the steering knuckle with the movable bearing pressed into same in the joint fork is subsequently carried out in another process step c). This premounting is carried out while the connection between the fixed bearing and the joint fork and/or the steering knuckle is at least partly not yet tightened and is loose such that the joint fork and the steering knuckle are now connected to one another in a loosely movable manner, only by means of the fixed bearing. A mounting gap provided in the area of the fixed bearing between the joint fork and the fixed bearing or between the fixed bearing and the steering knuckle is now maintained or opened, as a result of which the mounting gap is prepared for receiving a space-maintaining auxiliary element.

The mounting gap may be arranged either in the area of the joint fork, between the joint fork and the fixed bearing, or in the area of the steering knuckle, between the fixed bearing and the steering knuckle.

A space-maintaining auxiliary element is subsequently arranged in the mounting gap in another process step d) and the connection of the fixed bearing with the fork end or the steering knuckle, which was still loose before, is temporarily tightened. The space-maintaining auxiliary element is used for temporarily setting an exactly determined, additional axial distance between the steering knuckle and the joint fork, the additional axial distance thus set being used for the subsequent exact relative positioning of the outer ring element and the inner ring element in the central positions thereof. The effective thickness of the auxiliary element corresponds here exactly to the axial path of displacement of the movable bearing inner ring element between the eccentric mounted position thereof and the working position thereof in the central position of the inner ring element and the outer ring element.

In other words, this means that the distance in the axial direction of the bearing between the respective end stops for the outer ring element and the inner ring element in the bearing seat of the steering knuckle likewise corresponds exactly to the effective thickness of the space-maintaining auxiliary element.

The mounted position of the inner ring element corresponds to the position the inner ring element assumes during mounting when it is in contact with the end stop of the bearing seat in the steering knuckle, while the working position of the inner ring element corresponds to the central position of the inner ring element in the outer ring element during the operation of the joint arrangement.

A fixed connection is then established in another process step e) between the movable bearing-side fork end of the joint fork and the inner ring element of the movable bearing. This connection is established without any change in the eccentric relative positions of the inner ring element and the outer ring element and while the contact between the inner ring element and its end stop in the bearing seat is maintained or restored.

This means that the inner ring element of the movable bearing continues to be in its eccentric stop position at the end stop of the bearing seat of the steering knuckle and this stop position of the inner ring element is established or restored in connection with the establishment of the connection between the movable bearing-side fork end and the inner ring element if the inner ring element is not yet or no longer in its eccentric stop position in the bearing seat of the steering knuckle at this point in time.

Any dimensional tolerances that may possibly be present or even add up in the tolerance chain
“fixed bearing-side fork end→fixed bearing→pivotable steering knuckle→movable bearing→movable bearing-side fork end”
   and would compromise compliance with the intended central position of the movable bearing in a mounting process according to the state of the art within the framework of this process step are exactly and completely compensated and neutralized by the connection between the inner ring element and the movable bearing-side fork end being always established exactly while maintaining the space between the movable bearing-side fork end and the inner ring element, which space differs depending on the tolerance.

The space-maintaining auxiliary element between the steering knuckle and the joint fork, which was introduced in process step d), is again removed subsequently in another process step f), and the final mounting of the fixed bearing is carried out in another process step g).

The final mounting of the fixed bearing is carried out, for example, in such a form that the screw connection of the fixed bearing in its mount on the joint fork or on the steering knuckle, which screw connection was not yet tightened before or was loosened for removing the space-maintaining auxiliary element, is now tightened. However, a relative motion also takes place between the joint fork and the steering knuckle by the amount of the effective thickness of the previously removed, space-maintaining auxiliary element due to this tightening of the screw connection of the fixed bearing exactly until the fixed bearing, the joint fork and the steering knuckle assume their axial relative positions, which are exactly defined in the now definitively mounted fixed bearing.

However, the inner ring element of the movable bearing also assumes, automatically and always exactly, its intended central position or working position in the outer ring in this final axial relative position of the joint fork and steering knuckle, which is attained after removal of the space-maintaining auxiliary element, because the effective thickness of the now removed space-maintaining auxiliary element is selected to be such that it exactly agrees with the distance in the axial direction of the bearing of the two end stops for the outer ring of the bearing and the inner ring of the bearing in the bearing seat of the steering knuckle.

In other words, the mounting process according to the present invention makes it possible to mount the pivotable steering knuckle in the joint fork of the stationary wheel carriers in the form of a fixed bearing/movable bearing combination even when the joint fork has an essentially one-piece design and, in particular, cannot be split. At the same time, it is reproducibly and exactly guaranteed by the mounting process according to the present invention that the inner ring element and the outer ring element of the movable bearing will always assume the exact middle position necessary for the durable and reliable operation of the joint arrangement.

Thanks to the joint fork of the stationary wheel carrier, which can be designed with the present invention essentially in one piece and in an unsplit form, the non-spring-mounted masses are reduced rather substantially, which is favorably advantageous for driving safety and driving smoothness. Furthermore, the necessary space needed for installation, which is extremely limited precisely in the area of the wheel suspensions, is reduced compared to the hitherto necessary two-part design of the joint fork, and mounting of the components of the joint arrangement in a reliable process is facilitated and expedited.

Not only do these advantageous effects of the mounting process according to the present invention lead to the improvements of the product itself, which are desired according to the object of the present invention, but they also have the effect of reducing the reject rate in the manufacture and mounting of joint arrangements of this class and lead, last but not least, to a substantial reduction of the production costs as well as to an improvement of the ability of the mounting of joint arrangements of this class to be automated.

The present invention is embodied independently from how the connection is established between the movable bearing-side end of the joint and the inner ring element in process step e). Essentially all the connection methods that permit a reliable and rigid connection between the inner ring element and the fork end while maintaining the relative positions of the inner ring element and the steering axle or the relative positions of the inner ring element and the outer ring element are conceivable here, in principle.

However, the connection between the movable bearing-side end of the fork and the inner ring element of the movable bearing is established in process step e) in a process embodiment of the present invention by means of introducing a bolt means through a recess in the movable bearing-side end of the fork into the inner ring element.

The end of the bolt means associated with the inner ring element is rigidly connected here to the inner ring element, and the end of the bolt means associated with the fork end is rigidly connected to the fork end. In other words, a rigid connection is established in this manner between the movable bearing-side fork end and the inner ring element of the movable bearing, and the relative position between the inner ring element and the fork end in the axial direction of the bearing, which was established before on the basis of the space-maintaining auxiliary element, is at the same time maintained.

According to preferred embodiments of the present invention, the connection between the bolt means and the inner ring element and/or the connection between the bolt means and the fork end is established in the form of a force fit, in the form of a screw connection, or by means of connection in substance, for example, by soldering, welding or bonding. The connection between the bolt means and the inner ring element as well as between the bolt means and the fork end can be established in an especially simple manner, rapidly and at a low cost and especially advantageously by means of force fit because the pressing in of the bolt means into the inner ring element can take place in this case against the stop of the inner ring element in the bearing seat of the steering knuckle, without there being any risk that the position of the inner ring element relative to the steering knuckle would change during pressing in.

The present invention is also embodied independently from the design of the fixed bearing and/or the movable bearing and from how they are connected to the steering knuckle or the static wheel carrier as long as the axial loads are absorbed by the fixed bearing and the necessary compensation of differences in length and axial offsets are guaranteed by the movable bearing.

However, the fixed bearing is a ball and socket joint and the movable bearing is a plain bearing with an additional axial degree of freedom or a toroidal roller bearing according to preferred embodiments of the present invention. The embodiment with ball and socket joint as a fixed bearing is proven, robust and inexpensive. The ball and socket joint makes possible the necessary pivoting motions of the steering knuckle relative to the joint fork or the static wheel carrier, it can absorb heavy axial loads and permits, moreover, angular deviations, which develop, for example, due to elastic bending of the steering knuckle and/or the joint fork, without being damaged. Since the ball and socket joint does not have to absorb any axial offset as a fixed bearing, it can be designed as a compact and robust bearing with small clearance and high load-bearing capacity.

For example, a plain bearing, which is known per se, with an additional axial degree of freedom, or especially a toroidal roller bearing may be considered for use as a movable bearing, the movable bearing being arranged in the bearing seat of the steering knuckle in the described manner according to the present invention and being at first oriented eccentrically and subsequently mounted in the joint arrangement while setting its defined central position.

Toroidal roller bearings have the outstanding property in the area of rolling bearings of being able to absorb both an axial offset and incorrect angular positions due to a corresponding automatic relative orientation of the inner ring, outer ring and roll bodies. There are neither frictional forces known for usual movable bearings nor stick-slip effects, which occur in case of axial displacements and may lead to undesired vibrations or to loads on the rolling surface. The compensating motions of the bearing components of the toroidal roller bearings are also not associated with nonuniform surface pressures or with the development of harmful edge pressure in the area of the roll bodies.

The toroidal roller bearing also has an especially high load-bearing capacity because of the always uniform linear contact between the toroidal-concave bearing rings and the spherical roll bodies. In addition, the toroidal roller bearing is also always nearly free from deformations and clearance because of its special geometry, regardless of incorrect angular positions and independently from the axial offset absorbed, which is in turn favorable in this case for the smoothness of running of the wheel and the sensitivity and the absence of reaction of the steering.

Thus, the fact that all incorrect angular positions and axial offsets, which develop in the area of the wheel guide joint, for example, because of tolerances as well as due to deformations caused by forces during the operation of the vehicle, can be absorbed in the area of a single bearing surface arrangement, is a decisive advantage of the use of a toroidal roller bearing as a movable bearing in a wheel guide joint.

The process according to the present invention is also embodied independently from the manner in which the mounting gap is designed for producing the additional distance between the fixed bearing-side fork end and the steering knuckle as long as the space-maintaining auxiliary element can be arranged in the mounting gap in a simple manner.

According to a preferred embodiment of the process according to the present invention, the joint arrangement has a mounting bush, which can be displaced in the axial direction of the bearing, in the area of the connection between the fixed bearing and the fixed bearing-side fork end or between the fixed bearing and the steering knuckle, and the mounting gap, which has changed as a result, is arranged between the mounting bush and the fixed bearing-side fork end or between the mounting bush and the steering knuckle. By arranging the space-maintaining auxiliary element in the mounting gap formed by the displacement of the mounting bush, the additional distance between the fork end and the steering knuckle can be brought about or set in this manner in process step d) in a simple manner and with an especially good reproducibility.

The present invention pertains, furthermore, to a joint arrangement for a wheel guide, especially for an, e.g., driven axle of a motor vehicle. The joint arrangement comprises, in the manner known per se, a joint fork, which can be arranged on a vehicle axle or on a wheel carrier, and which is also called a static wheel carrier, as well as a steering knuckle carrying the wheel bearing. The joint fork and the steering knuckle are pivotably connected to one another by means of two axially aligned mounting points. One of the mounting points is designed here as a fixed bearing and the other mounting point as a movable bearing with axial degree of freedom as well as an additional pivot angle degree of freedom.

However, the joint arrangement is characterized according to the present invention in that the joint fork and the steering knuckle are each essentially of an unsplit or one-piece design, the outer ring element of the movable bearing being arranged in a recessed bearing seat of the steering knuckle, while the inner ring element of the movable bearing is connected to the movable bearing-side fork end of the joint fork. A mounting recess or a mounting gap of variable width is arranged in the area of the fixed bearing—between the fixed bearing-side fork and the fixed bearing or between the fixed bearing and the steering knuckle—for temporarily receiving a space-maintaining auxiliary element for producing a fixed, additional distance between the fixed bearing-side fork end and the steering knuckle.

Due to the fact that the joint fork of the stationary wheel carrier can be designed essentially as an unsplit and one-piece joint fork, the number of necessary components as well as the non-spring-mounted masses can be reduced, which improves driving safety and driving smoothness. Furthermore, compared to the two-part design of the joint fork, which has hitherto been necessary according to the state of the art, the space needed for installation, which is required for the joint arrangement and is extremely limited precisely in the area of wheel suspensions, can be reduced, and the mounting of the individual parts of the joint arrangement can be simplified and expedited. On the whole, a rather substantial reduction of the production costs can be achieved thanks to the present invention while the product quality is improved at the same time.

The present invention can be embodied regardless of how the fixed bearing and/or the movable bearing are actually designed and arranged at the steering knuckle or on the static wheel carrier as long as the axial loads can be absorbed by the fixed bearing and as long as the necessary compensation of axial offsets and differences in length is guaranteed in the movable bearing.

However, the connection between the inner ring element of the movable bearing and the movable bearing-side fork end is preferably established by means of a bolt means arranged at the movable bearing-side fork end of the joint fork, for example, by means of force fit between the bolt means and the inner ring element and/or between the bolt means and the fork end. The connection between the inner ring element and the fork end as well as between the bolt means and the fork end by means of a bolt means and force fit can be established in an especially simple manner and inexpensively and is, moreover, especially advantageous in respect to securing the position of the inner ring element relative to the steering knuckle when the bolt means is pressed in.

According to other preferred embodiments of the present invention, the fixed bearing is designed as a ball and socket joint and the movable bearing as a plain bearing with an additional axial degree of freedom or as a toroidal roller bearing. The embodiment with a ball and socket joint as a fixed bearing is robust and inexpensive; the ball and socket joint permits the necessary pivoting motions of the steering knuckle relative to the joint fork or the static wheel carrier, can absorb heavy axial loads and can, moreover, absorb angular deviations, which develop due to elastic bending of the steering knuckle and/or of the joint fork, without problems.

A plain bearing with an additional axial degree of freedom or a toroidal roller bearing with the advantages already described above may be used as a movable bearing. The movable bearing can be mounted, especially by the use of the mounting process according to the present invention, with a defined setting of its central position between the static wheel carrier and the pivotable steering knuckle, which can be set without problems in a reproducible manner in the production.

According to another, preferred embodiment of the present invention, the joint arrangement has a mounting bush, which is arranged between the fixed bearing and the fixed bearing-side fork end or between the fixed bearing and the steering knuckle and is displaceable in the axial direction of the bearing. The mounting recess or the mounting gap for temporarily receiving the space-maintaining auxiliary element is arranged here between the mounting bush and the fixed bearing-side fork end or between the mounting bush and the steering knuckle.

Thanks to the mounting gap, which can be formed by the displacement of the mounting bush and is of variable width, the additional distance between the fork end and the steering knuckle, which is necessary for setting the central position of the inner ring element of the movable bearing, can be produced in a simple and especially well reproducible manner.

The present invention will be explained in more detail below on the basis of drawings, which show an exemplary embodiment only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an embodiment of a joint arrangement according to the present invention with a space-maintaining auxiliary element in an intermediate mounting position in a partially cut-away side view;

FIG. 2 is a top view of the space-maintaining auxiliary element; and

FIG. 3 is a schematic view of the joint arrangement according to FIG. 1 in the completely mounted state in a representation and view corresponding to FIG. 1.

### DESCRIPTION OF THE PREFERRED EMBODIMENTS

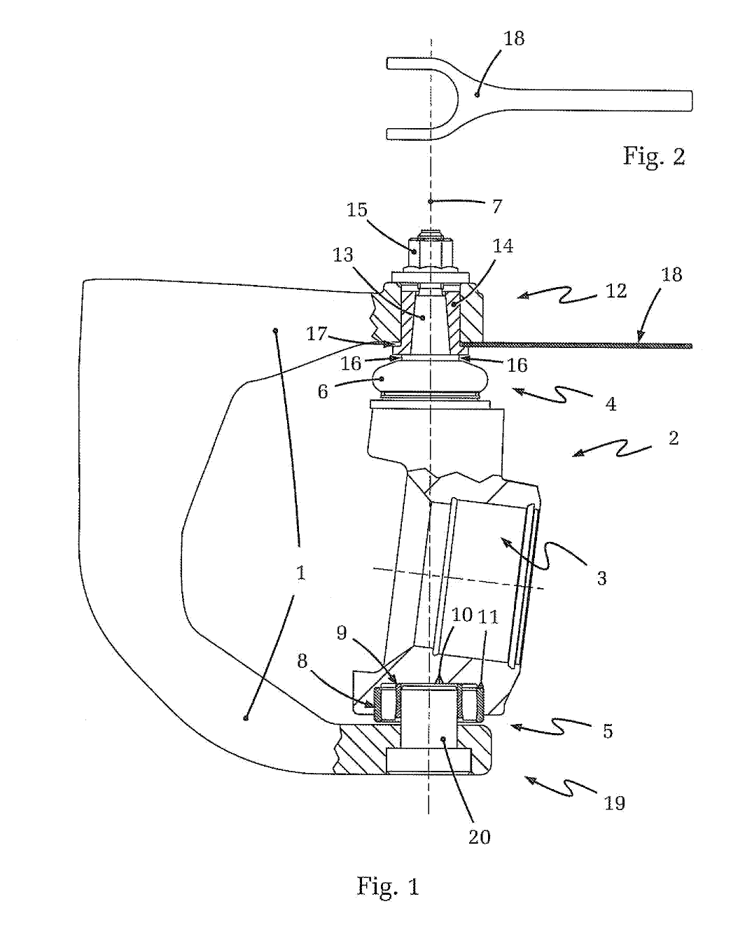

Referring to the drawings in particular, FIG. 1 shows an embodiment of a joint arrangement according to the present invention of a steered vehicle axle with a view in the direction of travel of the corresponding motor vehicle. The arrangement comprising a joint fork 1 associated with the static wheel carrier and a steering knuckle 2 as can be recognized in FIG. 1. The joint fork 1 is connected, on the side that is the left side relative to the drawing, for example, to a spring strut, not shown, or to an axle guide arrangement, while the steering knuckle 2 can receive the mount of a steered wheel, likewise not shown, in the passage recognizable at 3 on the right side relative to the drawing.

The joint fork 1 and the steering knuckle 2 have two common mounting points 4 and 5, one of the mounting points being designed as a ball and socket joint 4 with sealing bellows 6 and the other mounting point 5 being provided with a rolling bearing. The steering knuckle 2 is thus pivotable about the steering axle 7 formed by the common mounting points 4 and 5 in relation to the spring-mounted, but not steerable joint fork 1.

The rolling bearing 5 is designed here as a toroidal roller bearing, which tolerates, as was already described in the introduction, both a certain angular offset between its outer ring 8 and its inner ring 9, and can absorb axial displacements of the inner ring 9 in relation to the outer ring 8 practically without forces of reaction.

At the beginning of the mounting of the joint arrangement being shown, the toroidal roller bearing 5 forming the movable bearing is first pressed with its bearing outer ring 8 into the pot-shaped recess 10 on the underside of the steering knuckle 2, while the bearing outer ring 8 comes to lie at a ring-shaped circumferential collar 11 in the pot-shaped recess 10 of the steering knuckle 2 in an exactly defined manner in the axial direction of the bearing.

In the area of the fork end 12 of the joint fork 1 or of the static wheel carrier 1, which is the upper fork end relative to the drawing, the joint arrangement has a ball and socket joint 4, which can be recognized in FIG. 1 from the ball pivot 13 as well as from the sealing bellows 6. The ball and socket joint 4 forms the fixed bearing and is thus responsible, among other things, for absorbing the forces acting essentially vertically in the axial direction 7 of the bearing. The ball and socket joint 4 has a joint housing, which is fastened in a recess of the steering knuckle 2 by means of force fit and is not shown separately for clarity's sake.

After the movable bearing 5 with its bearing outer ring 8 has been pressed during the mounting into the pot-shaped recess 10 on the side of the steering knuckle 2, which is the lower side relative to the drawing, the ball pivot 13 of the ball and socket joint 4 is connected to the fork end 12 of the static wheel carrier 1, which fork end is the upper fork end relative to the drawing, via its conical shaft, via a mounting bush 14, which is correspondingly likewise conical on the inside, as well as via the screw connection 15. To achieve an exactly defined contact between the ball pivot 13 and the mounting bush 14 in the axial direction 7 of the bearing, the conical shaft of the ball pivot 13 has a circumferential shoulder 16, which comes into contact with the mounting bush 14 on the front surface that is the lower front surface relative to the drawing.

The mounting gap 17 for receiving a space-maintaining auxiliary element 18 is provided, moreover, at 17 between the lower front side of the fixed bearing-side, upper fork end 12 and the collar of the mounting bush 14. In the view in FIG. 1, the space-maintaining auxiliary element 18, whose fork-shaped design appears from the top view according to the view in FIG. 2, is arranged during mounting between the collar of the mounting bush 14 and the lower edge of the fixed bearing-side fork end 12. Due to the fact that the space-maintaining auxiliary element 18 is thus arranged in the mounting gap 17 between the collar of the mounting bush 14 and the lower front side of the fork end 12, the final mounted position of the ball pivot 13 and hence also of the entire ball and socket joint 4 as well as of the steering knuckle 2 is not yet reached during the mounting of the ball pivot 13 at the upper fork end 12. A determined additional, linear distance, which exactly corresponds to the thickness of the space-maintaining auxiliary element 18, rather remains between the preliminary mounted position reached with the mounted space-maintaining auxiliary element 18 and the final mounted position of the steering knuckle 2.

After the fixed bearing of the joint arrangement, i.e., the ball and socket joint 4, has been completely connected to the upper fork end 12 in this manner, with the inclusion of the space-maintaining auxiliary element 18, a stepped bolt 20 is pressed into the corresponding recess of the lower fork end 19 in the areas of the movable bearing 5 at the lower fork end 19, just as into the bearing inner ring 9 of the movable bearing 5 as well. The stepped bolt 20 forms a force fit corresponding to the fits selected with both the bearing inner ring 9 and the passage in the fork end 19 of the static wheel carrier 1.

However, at the latest at the moment of the operation in which the stepped bolt 20 is pressed in, the bearing inner ring 9 of the movable bearing 5 assumes a position shown in FIG. 1, which is displaced upwardly by an exactly defined amount relative to the drawing in relation to the bearing outer ring 8 of the movable bearing 5 in the axial direction of the bearing. The difference between the depth of the bottom of the pot-shaped recess 10 in the steering knuckle 2, which defines the position of the bearing inner ring 9, and the depth of the collar 11 extending circumferentially, with which the bearing outer ring 8 is in contact, i.e., the amount by which the bearing inner ring 9 is displaced when the stepped bolt 20 is pressed in relation to the bearing outer ring 8 in the axial direction of the bearing, now corresponds exactly to the thickness of the space-maintaining auxiliary element 18.

However, this means, in other words, that the bearing inner ring 9 and the bearing outer ring 8 of the movable bearing 5 also always have the same distance in the axial direction 7 of the bearing after the stepped bolt 20 has been pressed in, i.e., regardless of the particular tolerances, which are present in the tolerance chain
“fixed bearing-side fork end 12→fixed bearing 4→steering knuckle 2→movable bearing 5→movable bearing-side fork end 19”
   or they even add up there.

These tolerances or their sum are rather compensated when the stepped bolt 20 is pressed in automatically and exactly due to the fact that the stepped bolt 20 will automatically penetrate more deeply or less deeply into the bearing inner ring 9 of the movable bearing 5 as a function of the tolerances of the components. The stepped bolt 20 always reaches its end position in the axial direction of the bearing in relation to the lower fork end 19 due to the fact that the head of the stepped bolt comes into contact with the circumferential collar having a corresponding shape, which is milled into the passage of the lower fork end 19.

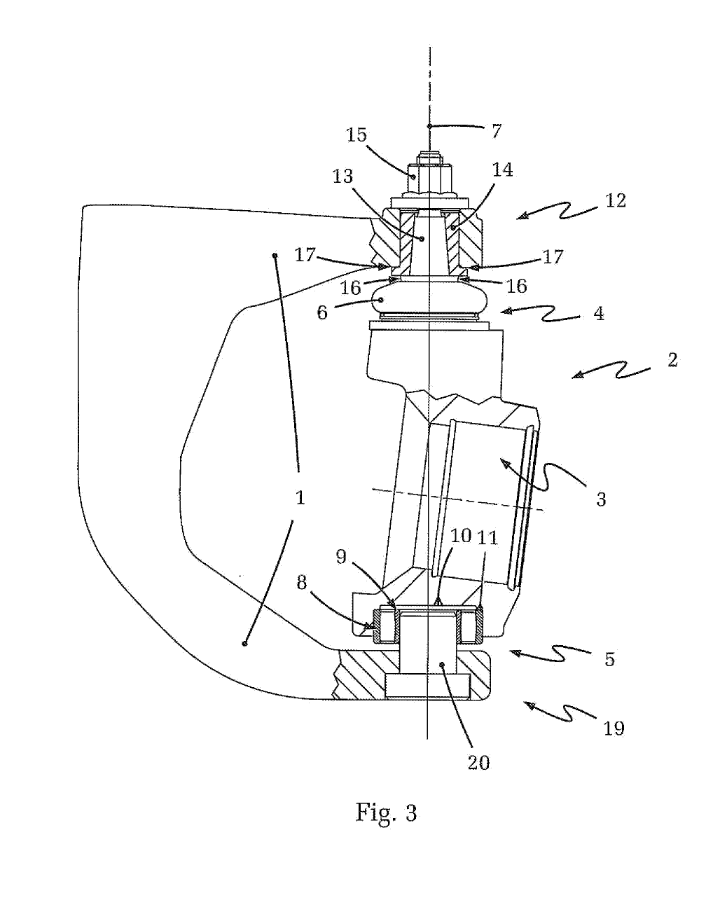

After the movable bearing 5 has thus reached its final mounted position both in reference to the steering knuckle 2 and in reference to the lower fork end 19, the space-maintaining auxiliary element 18 is removed from the mounting gap 17 between the mounting bush 14 and the lower front side of the upper fork end 12, while temporarily loosening the screw connection 15 in the area of the upper fork end 12. The screw connection 15 between the upper fork end 12 and the ball pivot 13 is subsequently tightened again. The final relative positions of all components of the joint arrangement, which have thus been attained, appear from the view in FIG. 3.

However, the entire unit formed by the fixed bearing or the ball and socket joint 4, the steering knuckle 2 as well as the bearing outer ring 8 of the movable bearing 5 has been displaced in this manner upwardly relative to the drawing by exactly the amount that corresponds to both the thickness of the now removed space-maintaining auxiliary element 18 and the difference between the stop depths 10 and 11 for the bearing inner ring 9 and the bearing outer ring 8 in the pot-shaped recess 10, which said difference equals this thickness. However, this means that the movable bearing 5 always assumes exactly its intended neutral position after removal of the space-maintaining auxiliary element 18 as well as after tightening the screw connection 15 between the upper fork end 12 and the ball pivot 13, completely independently from the tolerances, which are present in the individual components, for example, the joint fork 1, the steering knuckle 2, the ball and socket joint 4, the stepped bolt 20, etc., and may add up into a tolerance chain.

It is thus ensured that the movable bearing 5 is always in its neutral position according to FIG. 3 in the force-free state of the joint arrangement after complete mounting of the joint arrangement.

This is a decisive requirement for the deformations of the joint fork 1 and the steering knuckle 2, which inevitably develop during driving because of effects of the vehicle dynamics as well as because of temperature effects, for example, oblique positions or axial displacements, to be able to be absorbed by the movable bearing 5 without damage, without unacceptably great deformations developing in the mounting points 4 and 5.

It thus becomes clear as a result that thanks to the present invention, a mounting process as well as a joint arrangement for wheel suspensions, especially for steerable, driven or non-driven axles of motor vehicles, are provided, in which process and joint arrangement the exact middle position of the movable bearing is guaranteed in a reliably operating manner in a reliable process and in a constantly reproducible manner in production. Moreover, the joint arrangement can thus be designed as an especially compact, lightweight and space-saving joint arrangement. Finally, prolonged service life, reduced maintenance requirement as well as better comfort properties during use in the motor vehicle can be expected from the mounting process according to the present invention and the joint arrangement according to the present invention. Despite the improvements of the product or assembly unit, which are made possible by the present invention, it is also possible at the same time to reduce the costs for the construction, mounting and operation of wheel suspensions and axle systems.

Thus, the present invention makes a fundamental contribution in the area of wheel suspensions and axle systems, especially in respect to reliability of operation, cost effectiveness, low maintenance and driving smoothness.

While specific embodiments of the invention have been shown and described in detail to illustrate the application of the principles of the invention, it will be understood that the invention may be embodied otherwise without departing from such principles.

1-15. (canceled)

16. A process for mounting a wheel guide joint arrangement, for an axle of a motor vehicle, the process comprising the steps of:
providing a joint arrangement comprising a joint fork, which can be arranged on a vehicle axle and can be connected to an axle guide arrangement, and a steering knuckle, which carries a wheel bearing, wherein said joint fork and said steering knuckle can be connected pivotably to one another by two axially aligned mounting points with one of said mounting points being designed as a fixed bearing and the other of said mounting points being designed as a movable bearing having an outer ring element as well as an inner ring element with an axial degree of freedom and an additional pivot angle degree of freedom, said steering knuckle having a bearing seat, in which said outer ring element of said movable bearing can be received;
premounting said fixed bearing;
pressing said movable bearing into said bearing seat of said steering knuckle in a pressing in direction such that said outer ring element of said movable bearing is in contact with an end stop in said pressing in direction and said inner ring element of said movable bearing is in contact with another end stop in said pressing in direction, each of said end stop and said another end stop being directed in the axial direction of the bearing;
premounting said steering knuckle with said joint fork on the basis of an at least partially still loose connection of said fixed bearing to said joint fork means and/or said steering knuckle means while maintaining a mounting gap in the area of said fixed bearing;
arranging a space-maintaining element in said mounting gap to provide a fixed additional distance between a fixed bearing-side fork end and said steering knuckle, wherein an effective thickness of an auxiliary element corresponds to the axial path of displacement of said movable bearing inner ring element between the contact thereof with said end stop of a bearing seat in said steering knuckle and a central position of said inner ring element in said outer ring element;
establishing a rigid connection between a movable bearing-side fork end of said joint fork and said inner ring element of said movable bearing while said inner ring element is in contact by said end stop with said bearing seat of said steering knuckle;
removing said space-maintaining auxiliary element between said steering knuckle and said joint fork; and
finally mounting said fixed bearing.

17. A mounting process in accordance with claim 1, wherein said step of establishing a rigid connection between a movable bearing-side fork end of said joint fork and said inner ring element of said movable bearing is carried out by inserting a bolt through a recess in said movable bearing-side fork end as well as in said inner ring element, wherein an end of said associated with said inner ring element is rigidly connected to said inner ring element and said end of said bolt associated with said movable bearing-side fork end is rigidly connected to said movable bearing-side fork end.

18. A mounting process in accordance with claim 17, wherein the connection between said bolt and said inner ring element or between said bolt and said movable bearing-side fork end is established in the form of a force fit.

19. A mounting process in accordance with claim 17, wherein the connection between said bolt and said inner ring element or between said bolt and said movable bearing-side fork end is established by means of a screw connection.

20. A mounting process in accordance with claim 17, wherein the connection between said bolt and said inner ring element or between said bolt and said movable bearing-side fork end is brought about by a substance connection.

21. A mounting process in accordance with claim 16, wherein said fixed bearing is a ball and socket joint.

22. A mounting process in accordance with claim 16, wherein said movable bearing is a plain bearing with an additional axial degree of freedom.

23. A mounting process in accordance with claim 1, wherein said movable bearing is a toroidal roller bearing.

24. A mounting process in accordance with claim 16, wherein the connection between said fixed bearing and said fixed bearing-side fork end or between said fixed bearing and said steering knuckle is established by means of a mounting bush, which is displaceable in the axial direction of the bearing, wherein said variable mounting gap is arranged between said mounting bush and said fixed bearing-side fork end or between said mounting bush and said steering knuckle.

25. A wheel guide joint arrangement, especially for an axle of a motor vehicle, the joint arrangement comprising:
a joint fork, which can be arranged at a vehicle axle or at a wheel carrier, said joint fork being essentially a one-piece design;
a steering knuckle carrying a wheel mount, said steering knuckle being essentially a one-piece design;
first and second axially aligned mounting points, said joint fork and said steering knuckle being pivotably connected to one another by said axially aligned mounting points wherein one of said mounting points comprises a fixed bearing and the other of said mounting point comprises a movable bearing having an outer ring element and having an inner ring element with an axial degree of freedom as well as an additional pivot angle degree of freedom, said outer ring element of said movable bearing being arranged in a recessed bearing seat of said steering knuckle and said inner ring element of said movable bearing being connected to said movable bearing-side fork end of said joint fork, wherein a mounting recess or a mounting gap of variable width is arranged in an area of said fixed bearing for producing a fixed, additional distance between said fixed bearing-side fork end and said steering knuckle.

26. A joint arrangement in accordance with claim 25, wherein said inner ring element of said movable bearing is arranged on a bolt arranged at said movable bearing-side fork end of said joint fork.

27. A joint arrangement in accordance with claim 25, wherein said fixed bearing is a ball and socket joint.

28. A joint arrangement in accordance with claim 25, wherein said movable bearing is a plain bearing with an additional axial degree of freedom.

29. A joint arrangement in accordance with claim 25, wherein said movable bearing is a toroidal roller bearing.

30. A joint arrangement in accordance with claim 25, wherein a mounting bush, which is displaceable in an axial direction of the bearing, is arranged between said fixed bearing and said fixed bearing-side fork end and between said fixed bearing and said steering knuckle, wherein said mounting recess or said mounting gap is arranged between said mounting bush and said fixed bearing-side fork end or between said mounting bush and said steering knuckle.
